(19) United States
(12) Patent Application Publication
(10) Pub. No.: US 2005/0169100 A1
(43) Pub. Date: Aug. 4, 2005

(54) Method and apparatus for producing lightweight solidified material, pipe-type mixer apparatus, apparatus for producing solidifying material, and gravity adjusting apparatus

(76) Inventors: Shohei Chida, Tokyo (JP); Kazuhiro Watanabe, Tokyo (JP); Naofumi Matsukuma, Tokyo (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/768,975

(22) Filed: Jan. 30, 2004

(51) Int. Cl. B01F 7/04; B01F 15/02

(52) U.S. Cl. 366/169.2; 366/290; 366/325.3

(57) ABSTRACT

The invention provides a technique which is effective for reusing a hydrated fluid waste product or the like. A fluid raw material containing a water content and a solid content is changed to a lightweight solidifying material while being carried to a destination place, by adding or removing the water content by a gravity adjusting apparatus (1) so as to adjust gravity, next adding and mixing a solidifying material by means of a first pipe-type mixer (4), and next adding and mixing a lightening material by means of a second pipe-type mixer (5).

### BACKGROUND OF THE INVENTION

1. Field of the Invention

The present invention relates to a pipe-type mixer apparatus and a method of producing a lightweight soil material.

2. Description of the Prior Art

Dredge mud, for example, generated in a dredge construction generally has a high moisture ratio. In the case of casting the dredge mud away to a disposition place, a lot of period is required until a sufficient strength for the ground is generated in the soil. Taking the problem into consideration, the inventor of the present invention has proposed a treating method of continuously mixing the mud with a solidifying material within a carrier pipe. Specifically, the structures disclosed in Japanese Unexamined Patent Publication Nos. 1984-179197, 1991-77893, 1997-158245 and 2000-54428 correspond to the method mentioned abo0ve. Further, with respect to a pipe-type mixer (a mixing apparatus within a pipe passage) used for this method, the inventor has proposed the structure disclosed in Japanese Unexamined Patent Publication No. 2001-79827.

However, the prior arts mentioned above have the following problems.

(i) It is desirable to reuse a hydrated fluid waste product such as the dredge mud mentioned above on the basis of a reduction of the disposition place in recent years. However, a functionality and an added value are short only by adding the solidifying material as in the prior art mentioned above, and this method is hard to be utilized in a high civil engineering in recent years.

(ii) The prior art mentioned above corresponds to a continuous solidifying material adding treatment performed by the pipe-type mixer. However, the pipe-type mixer in the prior art mentioned above has a problem in view of a stability of a mixing ratio.

(iii) In the solidifying material adding treatment as in the prior art mentioned above, a powder granular material solidifying material such as a cement or the like may be directly added to the mud or the like, however, a solidifying material such as a cement milk or the like may be produced by previously mixing with a liquid such as a water or the like so as to be added to the mud or the like. Further, specifically, in the latter case, in order to perform a bulk treatment such as the dredge mud treatment, it is necessary to continuously supply a lot of solidifying materials.

In this case, since the solidifying material is solidified with age, the solidifying material can not be reserved. Accordingly, it is desirable to continuously produce and supply the solidifying material in the field. In this case, it goes without saying that it is desirable to continuously combine the powder granular material solidifying material with the liquid.

However, in the case of continuously combining the powder granular material solidifying material and the liquid, the powder granular material solidifying material tends to be attached to the moisture content so as to be consolidated, and there is fear that the solidifying material is attached to an inner surface of a passage or a container, and the passage and the container is closed thereby, so that it is very hard to continuously combine them.

(iv) In the case of adding the solidifying material to the hydrated waste product such as the mud or the like, a composition affects a solidifying property. Accordingly, the prior art has proposed a method of adjusting a gravity of the mud by adding water. However, it is impossible to correspond to the case having a high moisture ratio only by adding water. Therefore, it is preferable that a technique can securely adjust the gravity of the hydrated products having wide range of moisture ratios.

Accordingly, a main object of the present invention is to provide a technique which is effective for reusing a hydrated fluid waste product or the like. Another object is to provide a pipe-type mixer which can mix at a stable rate. The other object is to provide a solidifying material supplying apparatus which can produce an even homogenous lightweight soil material from a mud or a muddy water. The other object is to provide a gravity adjusting apparatus which can securely adjust a gravity of a hydrated material in wide moisture ratios.

### SUMMARY OF THE INVENTION

<Invention in Accordance with First Aspect>

A method of manufacturing a lightweight solidifying material of changing a fluid raw material containing a water content and a solid content to a lightweight solidifying material while carrying the fluid raw material to a destination place, by using a pipe-type mixer which is provided with a mixing pipe passage, a shaft member coaxially pivoted within the mixing pipe passage, a screw vane and an agitating blade arranged in parallel in the order from an upstream side on the outer surface of the shaft member, a rotation driving means of the shaft member, and at least one additive material supplying port arranged in a corresponding position to the agitating blade in the shaft member, and is structured such as to carry the fluid material supplied into the mixing pipe passage to the additive material supplying port via the rotated screw vane, thereafter supply an additive material to the fluid material from the additive material supplying port, and agitate and mix the fluid material and the additive material by the rotated agitating blade, comprising:
(A) a step of adjusting a gravity of the fluid raw material by adding or removing a water content;
(B) a step of continuously carrying the gravity adjusted fluid raw material via a carrier passage constituted by a pipe passage in which at least one the pipe-type mixer is interposed;
(B1) a solidifying material adding step of adding and mixing a solidifying material as an additive material to the fluid raw material under the carrying step by the pipe-type mixer interposed in the middle of the carrier passage; and
(B2) a lightweight material adding step of adding and mixing a lightening material as an additive material to the fluid raw material obtained by adding the solidifying material by another pipe-type mixer interposed in a downstream side of the pipe-type mixer in the solidifying material adding step; or supplying the lightening material from another additive material supply port of the pipe-type mixer in the solidifying material adding step and adding and mixing the lightening material to the fluid raw material obtained by adding the solidifying material.

In accordance with the manufacturing method mentioned above, it is possible to smoothly change the fluid raw material (a mud or muddy water generated in the construction field) containing the water content and the solid content to the lightweight solidifying material in the field and in the pipe passage carrying step. Deserving special mention, the lightening material such as bubbles, expanded beads or the like is hard in a homogenous mixing with the high hydrated fluid material such as the mud or the like. However, it is confirmed that an extremely more homogenous mixing than an initial forecast can be achieve by agitating and mixing the lightening material from the supply port rotating together with the shaft member with respect to the fluid material circulating within a narrow elongated space such as the pipe-type mixer while supplying in a rotating manner.

<Invention in Accordance with Second Aspect>

A method of manufacturing a lightweight solidifying material as recited in the first aspect, wherein a pressure pump is interposed in an upstream side of the pipe-type mixer adding the solidifying material in the carriage passage, and each of the additive materials is added and mixed while passing the gravity adjusted fluid raw material through the pipe-type mixer by utilizing a pressure of the pressure pump.

A very simple and energy saving system can be structured bypassing through the agitating and mixing position by the pipe-type mixer with utilizing the pressure of the pressure pump for carrying the fluid material, as mentioned above. It goes without saying that the structure and the advantage are obtained by employing a principle of the pipe-type mixer mentioned below.

<Invention in Accordance with Third Aspect>

An apparatus for manufacturing a lightweight solidifying material for changing a fluid raw material containing a water content and a solid content to a lightweight solidifying material while carrying the fluid raw material to a destination place, by using a pipe-type mixer which is provided with a mixing pipe passage, a shaft member coaxially pivoted within the mixing pipe passage, a screw vane and an agitating blade arranged in parallel in the order from an upstream side on the outer surface of the shaft member, a rotation driving means of the shaft member, and at least one additive material supplying port arranged in a corresponding position to the agitating blade in the shaft member, and is structured such as to carry the fluid material supplied into the mixing pipe passage to the additive material supplying port via the rotated screw vane, thereafter supply an additive material to the fluid material from the additive material supplying port, and agitate and mix the fluid material and the additive material by the rotated agitating blade, comprising:
(a) a means for adjusting a gravity of the fluid raw material by adding or removing a water content;
(b) a structure for continuously carrying the gravity adjusted fluid raw material via a carrier passage constituted by a pipe passage in which that least one the pipe-type mixer is interposed;
(b1) a structure for adding and mixing a solidifying material as an additive material to the fluid raw material under the carrying step by the pipe-type mixer interposed in the middle of the carrier passage; and
(b2) a structure for adding and mixing a lightening material as an additive material to the fluid raw material obtained by adding the solidifying material by another pipe-type mixer interposed in a downstream side of the pipe-type mixer in the solidifying material adding step; or supplying the lightening material from another additive material supply port of the pipe-type mixer in the solidifying material adding step and adding and mixing the lightening material to the fluid raw material obtained by adding the solidifying material.

The same operation and effect as those of the invention described in the invention in accordance with the first aspect can be achieved.

<Invention in Accordance with Fourth Aspect>

A pipe-type mixer apparatus comprising:
a mixing pipe passage having an upstream side supply portion to which a first fluid material is pressure supplied and a downstream side discharge portion from which a mixed material is discharged;
a shaft member coaxially pivoted within the mixing pipe passage;
a screw vane and an agitating blade arranged in parallel in the order from an upstream side on the outer surface of the shaft member;
a rotation driving means of the shaft member; and
a second fluid material supplying port arranged in a corresponding position to the agitating blade in the shaft member,
wherein the pipe-type mixer is structured such as to rectify the first fluid material supplied into the mixing pipe passage by the rotated screw vane, thereafter supply the second fluid material to the first fluid material from the supplying port in the shaft member, agitate and mix the first fluid material and the second fluid material by the rotated agitating blade, and discharge the agitated and mixed material via the discharge portion.

The pipe-type mixer apparatus in accordance with the present invention is structured by taking into consideration a pulsation (a quantity fluctuation with time) of the first fluid material. The case that the first fluid material is supplied by a piston pump or the like corresponds to this. In the case that the first fluid material is pressure supplied together with the pulsation, a mixing ratio cannot be stabilized by mixing the first fluid material with the second fluid material as it is. The prior art mentioned above has no point of view of the matter.

On the other hand, the apparatus in accordance with the present invention rectifies the first fluid material by the screw vane so as to change to the substantively continuous quantitative flow and thereafter mix with the second fluid material. In other words, in the case of carrying the material by the screw vane, the fluctuation in the material supply amount in the inlet side is cancelled on the basis of a quantitative extruding effect of the screw vane, and hardly gives any influence to an outlet side. The present invention prevents the pulsation of the first fluid material by utilizing this matter. Accordingly, in the present invention, it is possible to mix the first and second fluid material at a stable rate.

In this case, the matter that the screw vane is provided is disclosed in the prior art, however, the rectifying effect mentioned above cannot be achieved only by arranging the screw vane. A particular means for achieving the rectifying effect of the present invention can be variously considered in correspondence to the supply aspect of the first fluid material. The structure described in the following fifth aspect will be proposed as a representative structure.

<Invention in Accordance with Fifth Aspect>

A pipe-type mixer apparatus as recited in the fourth aspect, wherein a rectifying capacity per unit time achieved by the screw vane is equal to or more than a supply amount of the first fluid material per unit time.

In the case that the pressure feeding is employed at a time of supplying the first fluid material into the mixing pipe passage, when the first fluid material is supplied more than the rectifying capacity achieved by the screw vane (that is, such a supply amount of the first fluid material that the influence of the pulsation in the supply side can be sufficiently cancelled by the screw), an excess amount corresponds to a fluctuation amount of the mixing ratio. Accordingly, as described in the second aspect, it is desirable that the rectifying capacity per unit time achieved by the screw vane is equal to or more than the supply amount of the first fluid material per unit time.

<Invention in Accordance with Sixth Aspect>

A pipe-type mixer apparatus as recited in the fourth aspect comprising:
a mixing pipe passage having an upstream side supply portion to which a first fluid material is supplied in a non-pressurized state and a downstream side discharge portion from which a mixed material is discharged;
a shaft member coaxially pivoted within the mixing pipe passage;
a screw vane and an agitating blade arranged in parallel in the order from an upstream side on the outer surface of the shaft member;
a rotation driving means of the shaft member; and
a second fluid material supplying port arranged in a corresponding position to the agitating blade in the shaft member,
wherein the screw vane carries and discharges the first fluid material supplied within the mixing pipe passage on the basis of an extruding effect, and
wherein an extrusion amount per unit time achieved by the screw vane is equal to or more than a supply amount of the first fluid material per unit time.

The present invention targets at not only the aspect that the first fluid material is pressure supplied to the mixing pipe passage, but also the aspect that the first fluid material is supplied in the non-pressurized state. For example, the case that the fluid material is taken out from a material hopper so as to be dropped and supplied within the mixing pipe passage corresponds to this. In this case, if the extruding amount per unit time achieved by the screw vane is less than the supply amount of the first fluid material per unit time, it is impossible to stably and securely feed the supplied first fluid material to a downstream side portion of the screw vane so as to fill the first fluid material, the second fluid material and the mixed material in the portion, and it is hard to mix at a stable rate.

In the other hand, in the case that the structure is made such that the extruding amount per unit time achieved by the screw vane is equal to or more than the supply amount of the first fluid material per unit time, in accordance with the invention described in the sixth aspect of the present invention, it is possible to stably and securely feed the supplied first fluid material to the downstream side portion of the screw vane, and it is possible to fill the first fluid material, the second fluid material and the mixed material in the downstream side portion of the screw vane, so that it is possible to mix at a stable rate.

<Invention in Accordance with Seventh Aspect>

A pipe-type mixer apparatus as recited in any one of the fourth to sixth aspects, wherein a supply port of the first fluid material is provided in a corresponding position to the upstream side supply portion in the shaft member.

In this case, the first fluid material is rotationally supplied in accordance with the rotation of the shaft member. Accordingly, since the first fluid material can be supplied in a dispersion manner into the pipe, a sufficient rectifying effect can be achieved even in the case that the rectifying performance of the screw vane is lowered.

<Invention in Accordance with Eighth Aspect>

A pipe-type mixer apparatus as recited in the sixth aspect, wherein a hopper is connected to the upstream side supply portion of the mixing pipe passage, and the first fluid material reserved within the hopper is taken out by a quantitative feeder so as to be supplied to the upstream side supply portion.

In the pipe-type mixer apparatus in accordance with the present invention, it is possible to employ an aspect that the first fluid material is supplied from the hopper.

<Invention in Accordance with Ninth Aspect>

A pipe-type mixer apparatus as recited in any one of the fourth to eighth aspects, wherein the mixing pipe passage is structured such that a part or all of the downstream side of the agitating blade is positioned in an upper side of the corresponding portion to the screw vane and the agitating blade, whereby the first fluid material, the second fluid material and the mixed material are always filled at least in the downstream side portion of the screw vane.

A delivery resistance of the agitated mixed material is increased by employing the structure mentioned above, and the first fluid material, the second fluid material and the mixed material are always filled at least in the downstream side portion of the screw vane, so that it is possible to securely and sufficiently mix.

<Invention in Accordance with Tenth Aspect>

A pipe-type mixer apparatus as recited in the fourth aspect, wherein a boost screw vane promoting the delivery of the mixed material to the downstream side discharge portion is provided in a downstream side of the agitating blade in the shaft member.

In accordance with the provision of the boost screw vane, even in the case that the energy is absorbed at a time when the pressure supplied first fluid material passes through the screw vane, the agitated and mixed material is smoothly delivered. In particular, in the case that the downstream pipe passage of the mixed portion is long and the pipe passage resistance is large, and the case that the delivery resistance is intentionally applied as described in the ninth aspect, the extruding pressure is assisted and the risk of occlusion in the pipe passage is lowered by providing the boost screw vane mentioned above, so that this structure is preferable.

<Invention in Accordance with Eleventh Aspect>

A pipe-type mixer apparatus as recited in any one of the fourth to tenth aspects, wherein a cover member is provided in a front side of the second fluid material supply port in the shaft member in a rotating direction of the shaft member, the cover member rotates together with the shaft member and the agitated material is pushed away, whereby a supply space for the second fluid material is formed in a second fluid material supply port position.

In accordance with the structure mentioned above, it is possible to smoothly and securely supply the second fluid material in a dispersion manner to the first fluid material. It goes without saying that this aspect is particularly preferable in the case that the first fluid material is in the pressure fed state.

<Invention in Accordance with Twelfth Aspect>

A pipe-type mixer apparatus as recited in any one of the fourth to eleventh aspect, wherein the agitating blade includes a double function blade having an agitating operation and a mixed subject carrying operation, and a single function blade having only the agitating operation, and the double function blade and the single function blade are arranged along a spiral direction around the shaft member in accordance with an alternate arrangement such that one single function blade is interposed every one or two double function blade.

If only the double function blade having the agitating operation and the mixing subject carrying operation is arranged as the agitating blade, the carrying operation is dominant as a whole, and the carrying operation has priority over the agitating operation, so that a high mixing property cannot be obtained. On the other hand, in the case that the single function blade only having the agitating operation is mounted, the carrying efficiency is lowered, so that a continuous mixing property is deteriorated. Accordingly, it is possible to improve the mixing property without deteriorating the carrying property by employing the alternate arrangement in which one single function blade is interposed every one or two double function blade. In this case, this is confirmed by the experiments.

<Invention in Accordance with Thirteenth Aspect>

A pipe-type mixer apparatus as recited in any one of the fourth to twelfth aspects, wherein the agitating blade is formed in an elongated flat shape, and a plurality of the agitating blades are arranged along a spiral direction around the shaft member at a phase interval of 90 degree or 60 degree.

It is possible to more effectively agitate and mix by employing the structure such as the carrying interval or the like mentioned above. This matter is also confirmed by the experiments.

<Invention in Accordance with Fourteenth Aspect>

A pipe-type mixer apparatus as recited in any one of the fourth to thirteenth aspects, wherein the screw vane is formed such that a winding number is between 1 and 3, and a pitch is 0.4 to 0.8 times of a diameter of the mixing pipe,
wherein the agitating blade is arranged in 5 to 15 pitches at an interval between 4 and 6 sheets per 1 pitch, along a spiral direction around the shaft member,
wherein a rotational speed of the shaft member is between 150 and 200/πd (rpm) at a time of driving the apparatus, in which a diameter of the screw vane and the agitating blade is set to d, and
wherein a material flow speed v within the mixing pipe passage at a time of driving the apparatus is between 10 and 50 m/min.

In the pipe-type mixer in accordance with the present invention, the features mentioned above significantly appear particularly in the structure of the screw vane and the agitating blade and under the motion condition. Of course, it goes without saying that the features mentioned above appear in the other case.

<Invention in Accordance with Fifteenth Aspect>

A solidifying material supplying apparatus for mixing a powder granular material and a liquid so as to produce a solidifying material, and supplying the solidifying material to an external portion, comprising:
a means for dropping and supplying the powder granular material;
a means for supplying the liquid in a cascade to the dropping powder granular material in such a manner as to pinch or narrow down the powder granular material from the periphery of the powder granular material, and combining the powder granular material with the liquid; and
an agitating and mixing means for agitating and mixing the combined powder granular material and the liquid.

In the case of producing the solidifying material by mixing the powder granular material and the liquid, for example, in the case of mixing the cement with the muddy water or the water, it has been very hard to continuously combine both the elements as mentioned above. With respect to the problem, since the powder granular material is wrapped by the liquid by supplying the liquid in the cascade to the dropping powder granular material from the periphery of the powder granular material in such a manner as to pinch or narrow down the powder granular material, it is possible to securely combine both the elements without the powder granular material being attached to the periphery. Further, as a result, it is possible to obtain the solidifying material having a more accurate blending ratio.

<Invention in Accordance with Sixteenth Aspect>

A solidifying material supplying apparatus for mixing a powder granular material and a liquid so as to produce a solidifying material, and supplying the solidifying material to an external portion, comprising:
a means for dropping and supplying the powder granular material;
a means for swirling and dropping the liquid and dropping the powder granular material to the swirling portion, and combining the powder granular material with the liquid; and
an agitating and mixing means for agitating and mixing the combined powder granular material and the liquid.

As is different from the invention in accordance with the fifteenth aspect mentioned above, even by dropping the powder granular material into the swirling portion while swirling and dropping the liquid, and combining the powder granular material with the liquid, the powder granular material is combined with the liquid in such a manner as to be wrapped by the liquid. Accordingly, in the same manner as the invention in accordance with the fifteenth aspect, it is possible to securely combine both the elements without the powder granular material being attached to the periphery. Further, as a result, it is possible to obtain the solidifying material having a more accurate blending ratio.

<Invention in Accordance with Seventeenth Aspect>

A gravity adjusting apparatus comprising:
a gravity adjusting tank to which a fluid material including a moisture content and a solid content is input;
a volume measuring means for measuring a volume of the fluid material within the gravity adjusting tank;
a weight measuring means for measuring a weight of the fluid material within the gravity adjusting tank;
a gravity measuring means for determining a gravity on the basis of results of the volume measuring means and the weight measuring means;
a water adding means for adding water into the gravity adjusting tank in correspondence to the measurement results of the gravity measuring means, in such a manner that the fluid material within the gravity adjusting tank has a predetermined gravity; and
a water discharging means for discharging water from the gravity adjusting tank in correspondence to the measurement results of the gravity measuring means, in such a manner that the fluid material within the gravity adjusting tank has a predetermined gravity.

On the other hand, the invention relates to the gravity adjusting apparatus of the fluid material including the water content such as the mud or the like and the solid content, and the structure is made such that not only the water addition but also the water discharge can be executed at a time of adjusting the gravity. Only the gravity adjustment by adding water can not correspond to the hydrated materials having wide moisture ratios, the case that the fluctuation width of the moisture ratio is large, and the like. However, the present invention can correspond to the hydrated material having every moisture ratios, by employing the structure that the gravity can be adjusted by discharging water.

<Invention in Accordance with Eighteenth Aspect>

A gravity adjusting apparatus as recited in the seventeenth aspect, wherein the water discharging means is structured such as to suck and discharge a clear supernatant water of the fluid material reserved within the gravity adjusting tank.

In the case that the gravity is adjusted by sucking and discharging the clear supernatant water as mentioned above, there are advantages that the structure is very simple, a low cost is achieved, and it is easy to apply to the existing apparatus.

<Invention in Accordance with Nineteenth Aspect>

A gravity adjusting apparatus as recited in the seventeenth or eighteenth aspect, wherein the water discharging means is structured such as to suck and discharge the water content of the fluid material reserved within the gravity adjusting tank via a filter medium.

In the case that the gravity is adjusted by sucking and discharging the water content of the fluid material via the filter medium, it is possible to intend a rapidity and a security of the treatment. Further, in the degree mentioned above, the structure is simple, the cost is not increased, and it is easy to apply to the existing apparatus.

<Invention in Accordance with Twentieth Aspect>

A gravity adjusting apparatus as recited in any one of the seventeenth to nineteenth aspects, wherein the gravity adjusting apparatus is provided with an agitating and mixing means for agitating and mixing the gravity adjusted fluid material, and a delivering means for delivering the agitated and mixed fluid material to an external portion.

Since the gravity adjusting apparatus in accordance with the present invention temporarily reserves the fluid material within the gravity adjusting tank, a separation of the water content and the solid content makes progress. Accordingly, it is preferable that the gravity adjusted fluid material is supplied to the external portion via the agitating and mixing process, as mentioned above.

### BRIEF DESCRIPTION OF THE DRAWINGS

FIG. 1 is a flow chart of a method of producing a lightweight solidifying material in accordance with the present invention;

FIG. 2 is a flow chart of a method of producing a lightweight solidifying material in accordance with another aspect of the present invention;

FIG. 3 is a flow chart of a method of producing a lightweight solidifying material in accordance with the other aspect of the present invention;

FIG. 4 is a vertical cross sectional view showing a first example of a pipe-type mixer;

FIG. 5 is a vertical cross sectional view showing a second example of the pipe-type mixer;

FIG. 6 is a vertical cross sectional view showing a third example of the pipe-type mixer;

FIG. 7 is a vertical cross sectional view showing a fifth example of the pipe-type mixer;

FIG. 8 is a vertical cross sectional view showing a sixth example of the pipe-type mixer;

FIG. 9 is an enlarged vertical cross sectional view and a horizontal cross sectional view of a main portion of the pipe-type mixer, and shows states having different angles of rotation;

FIG. 10 is a schematic view of an agitating and mixing principle;

FIG. 11 is a vertical cross sectional view showing an example of another pipe-type mixer;

FIG. 12 is a vertical cross sectional view showing an example of the other pipe-type mixer;

FIG. 13 is a vertical cross sectional view showing an example in which a plurality of pipe-type mixers are connected;

FIG. 14 is a vertical cross sectional view showing another example in which a plurality of pipe-type mixers are connected;

FIG. 15 is a vertical cross sectional view showing the other example in which a plurality of pipe-type mixers are connected;

FIG. 16 is a vertical cross sectional view showing an example of a solidifying material supplying apparatus;

FIG. 17 is a vertical cross sectional view showing another example of the solidifying material supplying apparatus;

FIG. 18 is a vertical cross sectional view showing an example of a gravity adjusting apparatus;

FIG. 19 is a vertical cross sectional view showing another example of the gravity adjusting apparatus; and

FIG. 20 is a horizontal cross sectional view showing an example of an arrangement of a filter medium.

### DESCRIPTION OF THE PREFERRED EMBODIMENTS

A description will be in detail given below of embodiments in accordance with the present invention with reference to the accompanying drawings.

### <Embodiments of Method and Apparatus for Manufacturing Lightweight Solidifying Material>

### First Embodiment

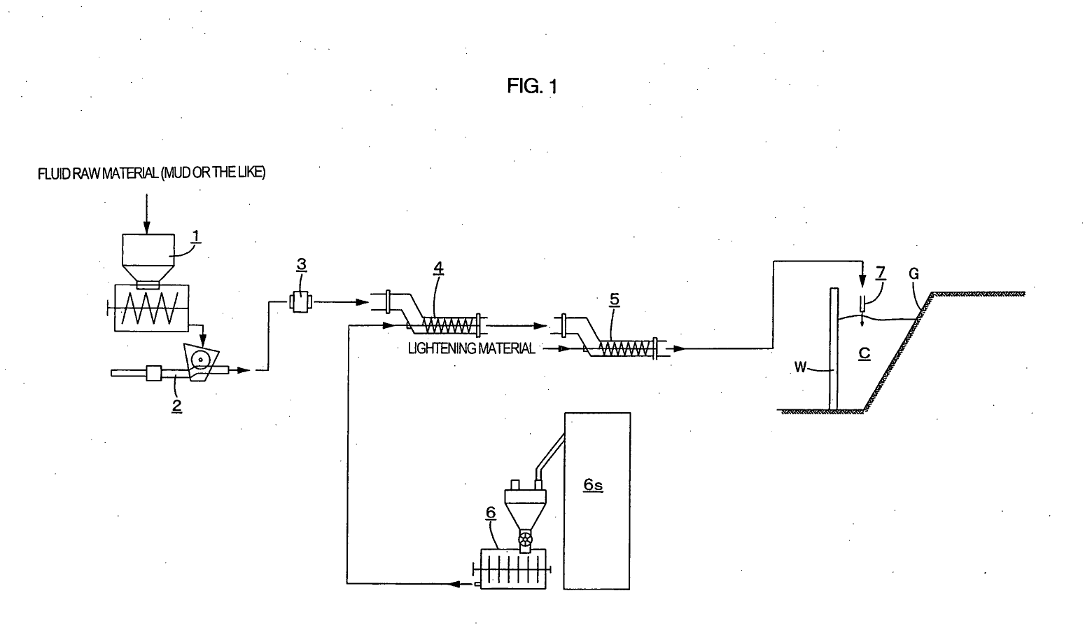

FIG. 1 shows a flowchart of a method of producing a lightweight solidifying material in accordance with the present invention. A fluid raw material used in the present invention is not particularly limited in kinds as far as the fluid raw material includes a water content and a solid content. However, a muddy water, a mud, and industrial wastes such as a slurry lime charcoal, a steel slug or the like are preferably used. If the muddy water and the mud are used, it is possible to produce a lightweight soil.

Such a secondary product has an uneven moisture ratio. Accordingly, in the present invention, first, a gravity adjustment is carried out by supplying a fluid raw material to a gravity adjusting apparatus 1 so as to measure the gravity, and adding or removing the water content on the basis of the measurement results in such a manner that a blending ratio with a later mixed solidifying material and lightening material becomes a desired rate. A concrete example of the gravity adjusting apparatus 1 will be described later, however, the gravity adjusting apparatus 1 preferably employs a structure having a function of flaking the fluid material, a gravity adjusting function and a re-mixing function.

The gravity adjusted fluid raw material is delivered to a carrier line by a pump apparatus 2. A first pipe-type mixer 4 and a second pipe-type mixer 5 are interposed in the carrier line, and the fluid raw material passes through these mixers in sequence. The pipe-type mixers 4 and 5 may use a common structure or a different structure as far as the mixers 4 and 5 satisfy the requirement of the present invention, that is, the structure which is provided with a mixing pipe passage; a screw vane and an agitating blade arranged in parallel in the order from an upstream side on the outer surface of the shaft member; a rotation driving means of the shaft member; and at least one additive material fluid material supplying port arranged in a corresponding position to the agitating blade in the shaft member, and is structured such as to carry the fluid material supplied into the mixing pipe passage to the additive material supplying port via the rotated screw vane, thereafter supply an additive material to the fluid material from the additive material supplying port, and agitate and mix the fluid material and the additive material by the rotated agitating blade. A preferable concrete example of the pipe-type mixer will be later described, however, the method in accordance with the present invention is not limited to this, and can employ the conventional pipe-type mixer.

In the first pipe-type mixer 4, the solidifying material supplied from the solidifying material supply apparatus is added and mixed from the additive material supply port of the rotating shaft member in a process of passing through the pipe passage. An illustrated embodiment is based on the case of supplying a powder granular material solidifying material (in this case, a raw material of the solidifying material) such as a cement or the like from a silo 6s to the solidifying material supply apparatus 6 at pleasure, mixing with the liquid such as the water or the like by the solidifying material supply apparatus 6 so as to form a slurry solidifying material, and thereafter supplying the slurry solidifying material to the first pipe-type mixer 4.

The fluid raw material to which the solidifying material is added in the first pipe-type mixer 4 is next passed through the second pipe-type mixer 5. In the second pipe-type mixer 5, a lightening material such as a cellular material, expanded beads, expanded resin crushed pieces or the like is added and mixed in a process of passing through the pipe passage.

Accordingly, the fluid raw material changes to the lightweight solidifying material in the carrying process bypassing through the first and second pipe-type mixers 4 and 5. At this time, the present first embodiment employs a structure of passing through the first and second pipe-type mixers 4 and 5 only on the basis of an original pressure of a pump for delivering the gravity adjusted fluid raw material to the carrier line, and a very simple and energy-saving structure is achieved. Further, the structure is made such that the blending ratio between the fluid raw material and the solidifying material or the lightening material in the first and second pipe-type mixers 4 and 5 can be determined by measuring a flow rate between the delivery pump and the first pipe-type mixer 4, and adjusting or controlling a supply amount of the solidifying material supply apparatus 6 or the supply amount of the lightening material in correspondence thereto.

In this case, the illustrated embodiment is based on the case of changing the fluid raw material to a lightweight solidifying material C and inputting the lightweight solidifying material C in the process of carrying the fluid raw material to a face of slope, at a time of inputting the lightweight solidifying material as a back surface banking of a retaining wall covering the slope surface G.

### Second Embodiment

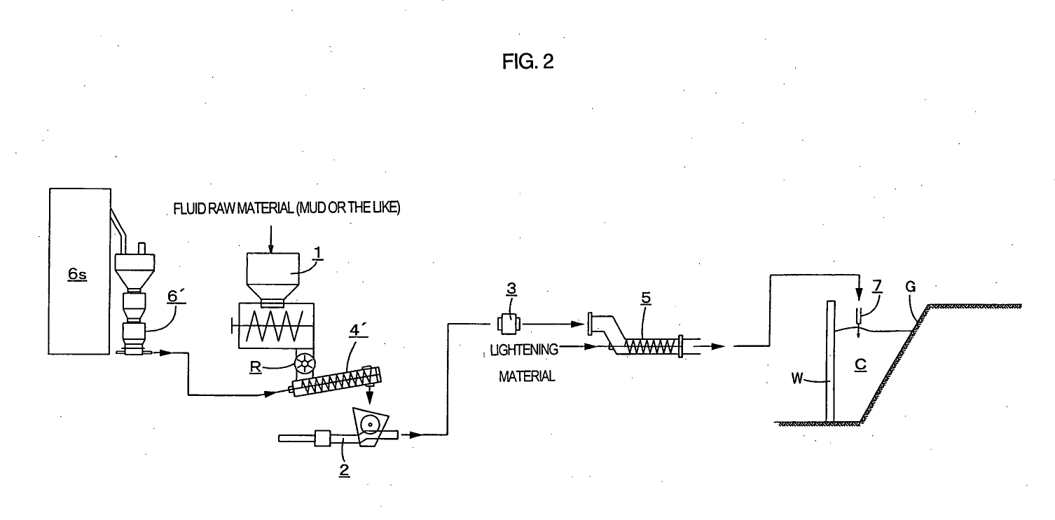

On the other hand, an embodiment illustrated in FIG. 2 shows a system structure example in the case of employing a hopper supply type pipe-type mixer 4′ (which is in detail described later as a fifth mixer example). In other words, the fluid raw material is supplied to the gravity adjusting apparatus 1, is gravity adjusted in the same manner as the embodiment shown in FIG. 1, is thereafter taken out at a predetermined amount continuously by a quantitative taking out means such as a rotary feeder R or the like, and is dropped and supplied to the first pipe-type mixer 4′.

The fluid raw material supplied to the first pipe-type mixer 4′ is carried in sequence on the basis of an extruding function (which is in detail described later) applied by the mixer, and a solidifying material supplied from a solidifying material supply apparatus 6′ is added and mixed in the carrying process. The illustrated embodiment is based on the case that the powder granular material solidifying material such as the cement or the like is supplied from the silo 6s to the solidifying material supply apparatus 6 at pleasure, and the solidifying material supply apparatus 6 continuously supplies a predetermined amount of powder granular material with keeping the powder granular material state to the first pipe-type mixer 4′. In this case, the blending ratio between the fluid material and the solidifying material can be determined by previously setting the supply amounts of the rotary feeder R and the solidifying material supply apparatus 6′.

The fluid raw material to which the solidifying material is added in the first pipe-type mixer 4′ is next supplied to the second pipe-type mixer 5 by the pressure pump 2, the lightening material is added and mixed in the process of passing through the pipe passage of the second pipe-type mixer 5 in the same manner as mentioned above, and the fluid raw material is changed to the lightweight solidifying material. In the present second embodiment, the structure is made such that since the supply amount of the fluid material to the second pipe-type mixer 5 is defined by the pressure flowrate of the pressure pump 2, a flow meter 3 is interposed between the pressure pump 2 and the second pipe-type mixer 5, and the blending ratio in the second pipe-type mixer 5 can be determined by adjusting or controlling the lightening material supply amount in correspondence to the measurement results. The others are the same as the first embodiment.

### Third Embodiment

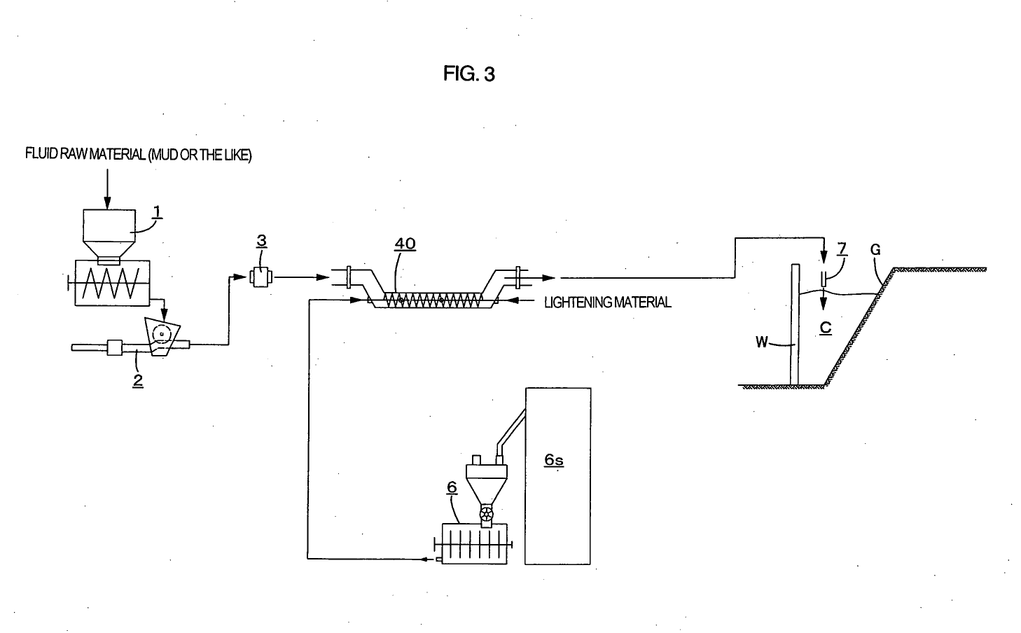

In the embodiments mentioned above, the pipe-type mixers are individually provided for adding the solidifying material and for adding the lightening material, however, the present invention can be structured, as shown in FIG. 3, such that one pipe-type mixer 40 (the pipe-type mixer 40 in the drawing corresponds to an embodiment shown in FIG. 11 mentioned below) is provided with a plurality of additive material supply ports at a suitable interval in a longitudinal direction of the shaft member, the solidifying material is added from an upstream side supply port, and the lightening material is added from a downstream side supply port. In this case, it is necessary to set the agitating and mixing portion long, however, since one pipe-type mixer 40 can add and mix the solidifying material and the lightening material as a whole, there is an advantage that the system can be made compact.

### Modified Embodiment

As is known from the comparison between the first and second embodiments mentioned above, in the case that the pipe-type mixers are used in series, the pressure pump can be arranged in a suitable plate (one place or a plurality of places) so as to carry the material.

Further, as far as the solidifying material and the lightening material are added and mixed in this order, it is possible to add one or a plurality of pipe-type mixers, or it is possible to add one or a plurality of additive material supply ports to the shaft member, whereby it is possible to add the same or different kind of material before, during or after adding the solidifying material and the lightening material. Specifically, it is possible to mix a coal ash as the first lightening material after adding and mixing the solidifying material and input bubbles as the second lightening material, and many variations can be employed.

### <Embodiment of Pipe-Type Mixer>

### FIRST MIXER EXAMPLE

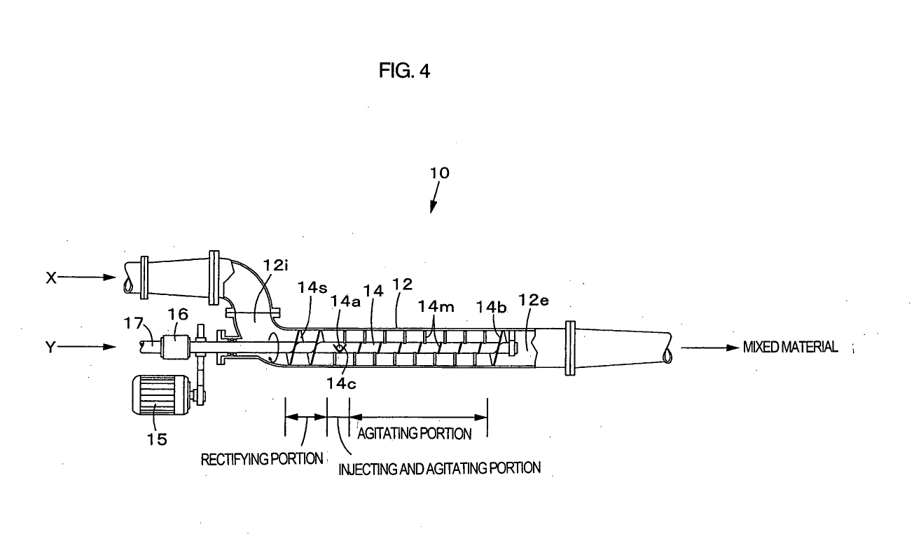

FIG. 4 shows an embodiment in the case of pressure supplying a first fluid material X such as a mud or the like into a pipe-type mixer apparatus 10 by a pump or the like. In other words, the pipe-type mixer apparatus 10 is structured such that a shaft member 14 is coaxially pivoted within a space of a mixing pipe passage 12 having an upstream side supply portion 12i and a downstream side discharge portion 12e, and a lot of screw vanes 14s and agitating blades 14m are provided in an outer peripheral surface of the shaft member 14 at an interval in a longitudinal direction in the order from an upstream side. A base end portion of the shaft member 14 is penetrated to an outer side of the pipe via an S-shaped curved portion of the mixing pipe passage 12, and is connected to a rotation driving means 15 such as a motor or the like so as to freely transmit a power. Further, the shaft member 14 is formed as a hollow member, an injection port 14a communicating with inner and outer sides is formed in a position corresponding to a middle of the agitating blade forming portion, a base end opening is communicated with a supply pipe passage 17 via a swivel apparatus 16, and a second fluid material Y is supplied to a forming portion of the agitating blade 14m from the supply pipe passage 17 via an inner side of the shaft member 14 and an injection port 14a in this order.

The first fluid material X is pressure supplied to the supply portion 12i of the pipe-type mixer apparatus 10 mentioned above, for example, by a piston pump or the like. The first fluid material pressure supplied into the mixing pipe passage 12 is first energy absorbed and rectified by the rotated screw vane 14s so as to form a continuous quantitative flow. At this time, an auxiliary agitating is simultaneously carried out in correspondence to the kind of the first fluid material X. In particular, when the first fluid material X is pressure supplied by an intermittent supplying means such as a piston pump or the like, the first fluid material reaches the screw vane 14s in accordance with a wave pattern in which a state of pressure feeding on the basis of the valve change and a state of stopping pressure feeding are repeated in a moment of time and alternately. The screw vane 14s in accordance with the present invention absorbs energy of a wave pressure and also has a function of sucking and extruding at a time when the pressure feeding is stopped.

Next, the first fluid material rectifying the screw vane 14s is preliminarily agitated by the agitating blade 14m rotated in an upstream side of the injection port 14a, and is thereafter combined with the second fluid material Y quantitatively supplied from the injection port 14a. The first fluid material and the second fluid material are agitated and mixed by the agitating blade 14m rotated in the injection port position and in a downstream side thereof, and the agitated and mixed material is discharged via the discharge portion 12e.

In particular, in the case of pressure supplying the first fluid material X as in the present embodiment, in order to achieve the rectifying operation mentioned above, it is recommendable to structure such that a rectifying capacity per unit time by the screw vane 14s becomes equal to or more than the supply amount of the first fluid material X per unit time. The rectifying capacity of the screw vane 14s can be determined on the basis of the test, and the supply amount of the first fluid material X can be determined on the basis of the predetermined pump volumetric capacity and can be measured by interposing the flow meter or the like in the upstream side of the pipe-type mixer apparatus 1. Further,in order to achieve the above matter, it is possible to suitably set or control a rotational speed of the screw vane 14s by the rotation driving means 15 in correspondence to the supply amount of the first fluid material, and it is possible to suitably design a size and a shape of the screw vane 4s, the pipe passage volumetric capacity and the like.

In the pipe-type mixer apparatus 1 structured in the manner mentioned above, the first fluid material supplied within the mixing pipe passage 12 can be mixed with the second fluid material Y after being formed as a stable continuous quantitative flow in accordance with the rectifying operation by the screw vane 14s. Accordingly, in the present invention, it is possible to mix the first and second fluid materials X and Y at a stable rate. In the pipe-type mixer of the present invention having the rectifying operation mentioned above, particularly, even in the case that the first fluid material X is supplied by the intermittent supplying means such as the piston pump or the like, a pulsation thereof can be cancelled by the screw vane and a continuous quantification can be achieved.

The first fluid material X in the present first mixer example can employ the mud group such as the slurry coal ash, the steel slug and the like in addition to the muddy water and the mud, and the second fluid material Y can employ a material to be mixed with the mud group such as the expanded material, the coal ash, the expanded beads, the fluidizing agent, the filter material and the like, in addition to the cement and the lime solidifying material.

For example, the solidified soil can be produced by supplying the mud group as the first fluid material X in accordance with the pump pressure feeding, and adding and mixing the solidifying material or the like as the second fluid material. As the solidifying material or the like in this case, in the present first mixer example, both the powder granular material and the slurry material can be applied. In this case, since the powder granular material solidifying material is supplied while riding on a pressurized air, in the case that no exhausting means is provided in the mixing pipe passage 12 as in the present example, there is formed a mixed gas pressure feeding in which the air is mixed in the mixed material. In this case, the pressure for pressure feeding the mixed material to the discharge portion 12e is constituted by adding the pressure of the supply air of the powder granular material solidifying material to the supply pressure of the mud. On the other hand, in the case of adding and mixing the slurry solidifying material, the mixed gas pressure feeding is not formed. In this case, the pressure for pressure feeding the mixed material to the discharge portion 12e is constituted by the supply pressure of the mud group.

### SECOND MIXER EXAMPLE

When a part or all of the downstream side of the agitating blade 14m is positioned in a lower side of the corresponding portion to the screw vane 14s and the agitating blade 14m, as in the case that the mixing pipe passage 12 is constituted by the straight pipe, is arranged horizontally and discharges from the end portion opening as in the first example, the case that the mixing pipe passage is constituted by the straight pipe, is arranged horizontally and has a discharge portion in a bottom surface (which is not illustrated), and the like, the material is hard to be filled in the corresponding portion to the screw vane 14s and the agitating blade 14m due to a small delivery resistance of the mixed material, so that there is assumed the case that the mixing can not be performed at a desired rate.

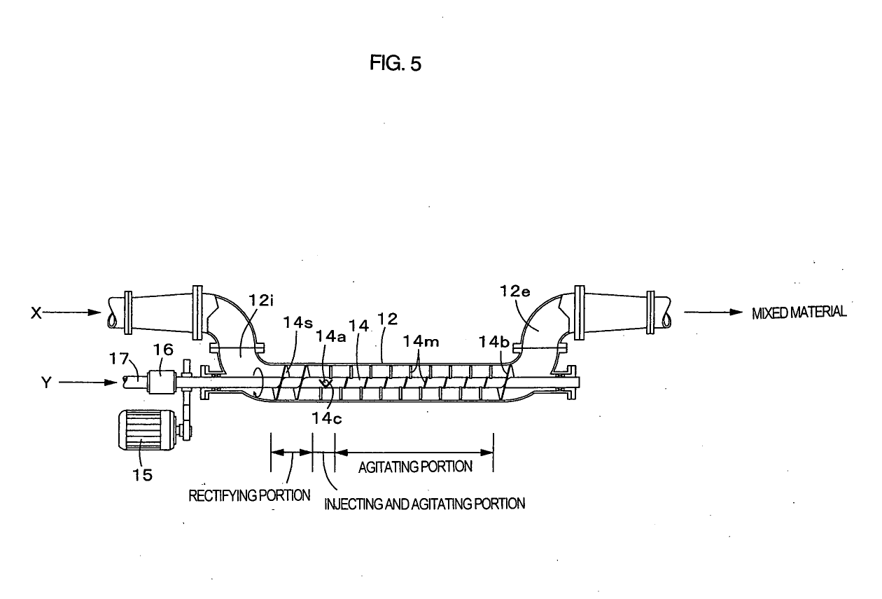

The second example shown in FIG. 5 is structured such that the corresponding portion to the screw vane 14s and the agitating blade 14m in the mixing pipe passage 12 is constituted by the straight pipe and is arranged horizontally, however, the downstream side portion of the agitating blade 14m is bent, and the discharge portion 12e is positioned in an upper side of the corresponding portion to the screw vane 14s and the agitating blade 14m. By employing the structure mentioned above, the delivery resistance of the agitated and mixed material is increased while the mixing pipe passage 12 is constituted by the straight pipe and is arranged horizontally. The fluid material is filled in the corresponding portion to the screw vane 14s and the agitating blade 14m, and it is possible to securely and sufficiently mix. Further, if the delivery resistance of the agitated and mixed material exists, it is possible to discharge a stable amount. Accordingly, it is easy to control an amount.

### THIRD MIXER EXAMPLE

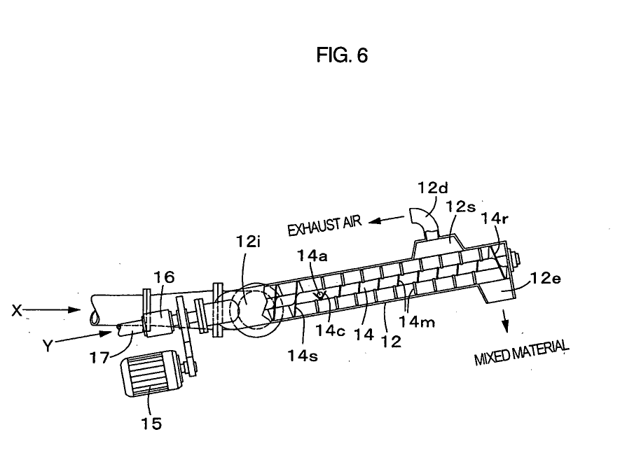

As shown in FIG. 6, it is possible to increase the delivery resistance of the mixed material and it is possible to fill the material in the agitated and mixed portion, even in the case that the mixing pipe passage 12 is constituted by the straight pipe, and an entire of the pipe 2 is inclined such that the downstream side is an upper side. In the illustrated embodiment, the discharge portion (the discharge port) 12e is provided in a bottom portion of the downstream side end portion of the mixing pipe passage 12, however, since the discharge portion 12e is positioned at the upper side of the corresponding portion to the screw vane 14s and the agitating blade 14m, the delivery resistance of the mixed material is increased in the same manner. Further, the upstream side bent portion is bent in a horizontal direction only in the example illustrated in FIG. 6, however, the same structure can be employed in the other examples.

### FOURTH MIXER EXAMPLE

Although an illustration is omitted, the structure may be made such that the mixing pipe passage is constituted by the straight pipe, and the discharge portion 12e is provided in an upper portion of the downstream side end portion. Accordingly, it is possible to increase the delivery resistance of the mixed material by overflowing the mixed material, and it is possible to fill the material in the agitating and mixing portion.

### FIFTH MIXER EXAMPLE

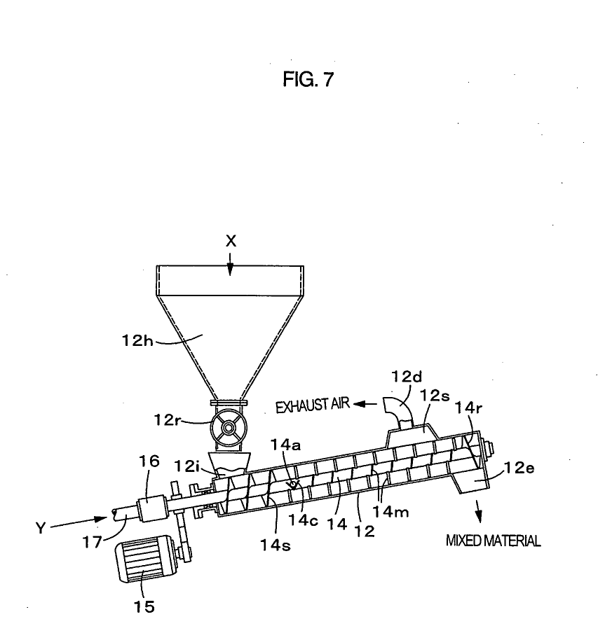

On the other hand, FIG. 7 shows an embodiment which is preferable in the case that the first fluid material X is supplied into the mixing pipe passage 12 in a non-pressure feeding state. The pipe-type mixer apparatus in accordance with the second embodiment is different from the other embodiments in a point that the mixing pipe passage 12 is formed in a straight pipe shape, the supply portion (the supply port) 12i for dropping and supplying the first fluid material X is formed so as to be communicated with an upper wall at a corresponding position to a screw vane 14s forming portion, and the hopper 12h is communicated with the supply portion via a quantitative feeder (a rotary feeder in the drawing) 12r. The other structures are basically the same as the embodiments mentioned above.

In the pipe-type mixer apparatus, the first fluid material X reserved in the hopper 12h is taken out by the quantitative feeder 12r, and is dropped and supplied into the mixing pipe passage 12 via the supply portion 12i. The supplied first fluid material X is extruded as a continuous quantitative flow to the discharge portion 12e on the basis of the extruding operation of the screw vane 14s. The extruded first fluid material is preliminarily agitated (premixing) by the agitating blade 4m rotated in the upstream side of the injection port 14a, and is thereafter combined with the second fluid material Y quantitatively injected and supplied from the injection port 4a, and the first fluid material and the second fluid material are agitated and mixed by the agitating blade 14m rotated at the position of the injection port 14a and the downstream side thereof, and the agitated and mixed material is discharged via the discharge portion 2e.

In the case that the first fluid material X is supplied in the non-pressure feeding state as mentioned above, if the extruding amount of the screw vane 14s per unit time is less than the supply amount of the first fluid material X per unit time, it is impossible to stably and securely deliver the supplied first fluid material X to the downstream side portion of the screw vane 14s so as to fill the material in the portion, and it is hard to mix at a stable rate. Accordingly, it is recommendable to make the extruding amount per unit time by the screw vane 14s equal to or more than the supply amount of the first fluid material X per unit time. Accordingly, it is possible to always fill the material in the downstream side of the screw vane 14s. In this case, the mixing material at the extruding amount by the screw vane 14s can be securely discharged from the mixer apparatus.

### SIXTH MIXER EXAMPLE

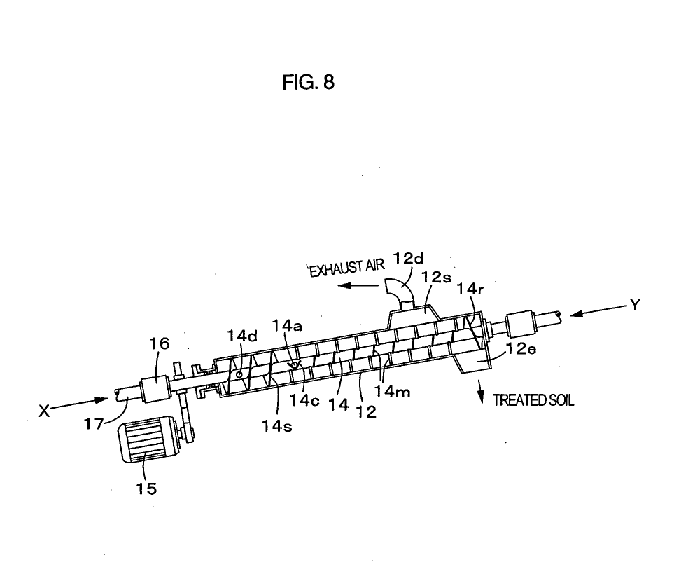

Further, in the present invention, as shown in FIG. 8, the first fluid material X can be supplied within the mixing pipe passage 12 from the supply port 14d which is independently provided in the shaft portion 14. In this case, the structure can be made such that the shaft portion 14 is constituted by a double pipe (or may be constituted by two parallel pipes), discharge ports 14a and 14d of the respective flow passages are open to an outer surface of the shaft member, one of them is used for the first fluid material X, and another of them is used for the second fluid material Y. In this case, it is possible to produce the slurry solidifying material and the solidifying soil, for example, by supplying the powder granular material or the slurry solidifying material from the downstream side as well as supplying the mixed water, the muddy water or the mud from the upstream side.

(Detail Structure of Mixer)

As is mentioned in a section of the first mixer example, in the case of supplying the slurry material in accordance with the pump pressure feeding and supplying the powder granular material by the pressure air, the mixed gas pressure feeding is achieved without the exhausting means. In this case, it can be assumed the case that it is impossible to carry smoothly because the air tends to generate a volume change. In the case mentioned above, as shown in the third and fourth examples, it is preferable that the exhausting means is provided in an upper portion in a downstream side of the powder granular material supply apparatus in the mixing pipe passage 12. In the illustrated embodiment, it is preferable that the exhausting means is installed by arranging a recess space 12s in a predetermined position of the mixing pipe passage 12, communicating the exhaust port 12d with an upper portion of the recess space 12s and the like. On the other hand, in the case of supplying the solidifying material or the like in the slurry state, the exhausting means is not required.

Further, in the aspect of pressure supplying the first fluid material X, since there is the rectifying and energy absorbing effect achieve by the screw vane 14s, the energy for delivering the mixed material is reduced, and the case that it is impossible to smoothly discharge is assumed. Accordingly, as shown in FIGS. 4 and 5, it is preferable that a boost screw vane 14b for promoting the delivery of the mixed material to the downstream side discharge portion is provided in a downstream side of the agitating blade 14m in the shaft member 14. In this case, in an example shown in FIGS. 6 to 8, a screw vane 14r provided in the downstream side of the agitating blade 14m in the shaft member 14 does not have the boost operation. This is structured such that a carrying direction is opposite to the carrying direction of the screw vane 14s and the boost screw vane 14b in the upstream side, and the mixed material extruded in sequence from the agitating blade is pushed back without passing through the above of the discharge port 12e in the lower portion of the mixing pipe passage 12 so as to be smoothly dropped into the discharge port.

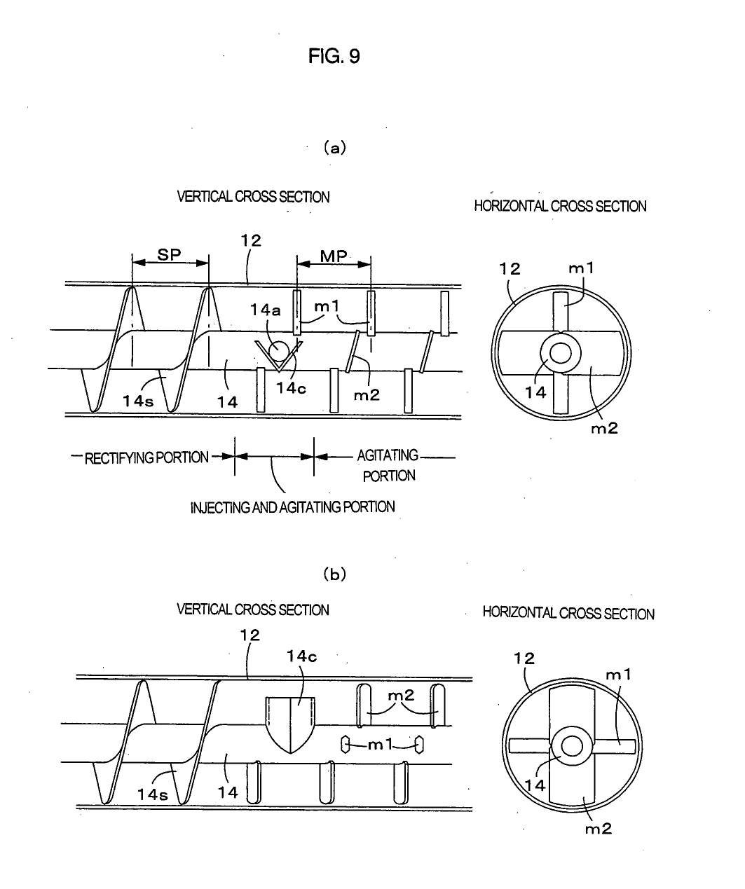

Further, in the pipe-type mixer in accordance with the present invention, as shown in FIGS. 3 to 9, a structure in which the cover member 14c is provided in a front side of the second fluid material supply port 14a in the shaft member rotating direction is also a preferable aspect. Since the cover member 14c rotates while pushing away the agitating material together with the shaft member 14, a supply space (a cavity) for the second fluid material is always formed at a position of the second fluid material supply port 14a, and the second fluid material is delivered to the space from the supply port 14a. Accordingly, it is possible to smoothly and securely distribute and supply the second fluid material into the first fluid material. In this case, FIGS. 9(a) and 9(b) show states in which a carrying angle is different at 90 degree from each other in a comparative manner, and both structures are the same.

Further, in accordance with a preferable aspect, as in detail shown in FIG. 9, the agitating blade 14m in accordance with the present invention is constituted by a double function blade m2 having an agitating operation and a mixed subject carrying operation, and a single function blade m1 having only the agitating operation, and one single function blade m1 is interposed every one or two double function blade m2 along the spiral direction around the shaft member 14 in accordance with an alternate arrangement. In the illustrated embodiment, the double function blade m2 is formed as a flat body which is inclined at a predetermined angle with respect to a surface orthogonal to an axis, and on the other hand, the single function blade m1 is formed as a flat body which is in parallel to the surface orthogonal to the axis. By employing the alternate arrangement mentioned above, it is possible to improve a mixing property without deteriorating the carrying property.

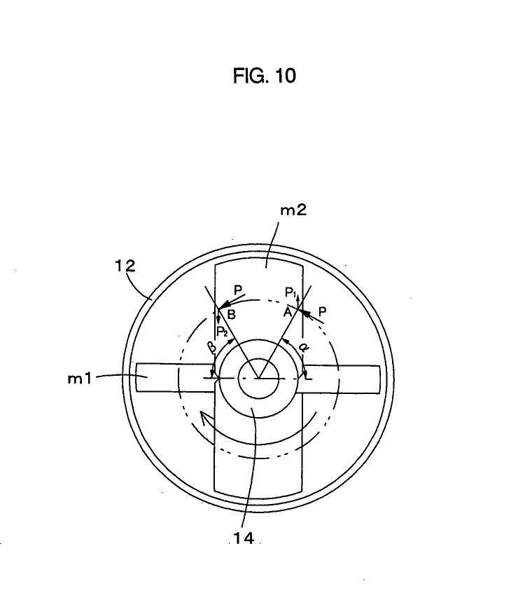

It may be considered that it is desirable to form the double function blade m2 in a propeller shape (a curved plate shape) obtained by partly cutting the screw. However, it is actually preferable to form the double function blade in a flat plate shape as illustrated so as to be arranged with respect to the shaft, because the motion of the mud group is changed in correspondence to the position in contact with the mud, and the mixing and agitating property is made higher. In other words, as shown in FIG. 10, at a point A and a point B on the same rotation radius, an extruding force P applied perpendicularly to the rotational direction generates a moving force P1 toward an outer side at the point A along a surface of the flat double function blade, and generated a moving force P2 toward an inner side at the point B, thereby increasing the agitating effect.

In this case, the pipe-type mixer in accordance with the present invention can be functioned only by any one agitating blade by adjusting the supply pressure of the first fluid material.

Further, in the case that a plurality of agitating blades 14m in accordance with the present invention are arranged at a phase interval of 90 degree or 60 degree along the spiral direction around the shaft member 14, it is known that a more effective agitating and mixing can be achieved.

Further, the inventors of the present invention have known on the basis of the results of research and development to the present that the following combination of the structure of the screw vane 14s and the agitating blade 14m and the operating condition is very preferable.
(1) Winding number of screw vane: 1 to 3
(2) Pitch of screw vane (SP): 0.4 to 0.8 times of diameter of mixing pipe
(3) Arrangement of agitating blade: spiral arrangement
(4) Number of agitating blade: 5 to 15 pitch at interval of 4 to 6 blades per 1 pitch (MP)
(5) Rotational speed of shaft member at driving time: 150 to 200/πd (rpm)
in which d is a diameter of the screw vane and the agitating blade
(6) Material flow speed v within mixing pipe passage: 10 to 50 m/min

### EXAMPLE OF SETTING A PLURALITY OF SUPPLY PORTS IN SHAFT MEMBER

On the other hand, in the pipe-type mixer apparatus in accordance with the present invention, the structure may be made such that three or more supplying means are provided in one pipe-type mixer apparatus, and two or three or more kinds of materials are supplied into the mixing pipe passage via further more passages than that of the example mentioned above.

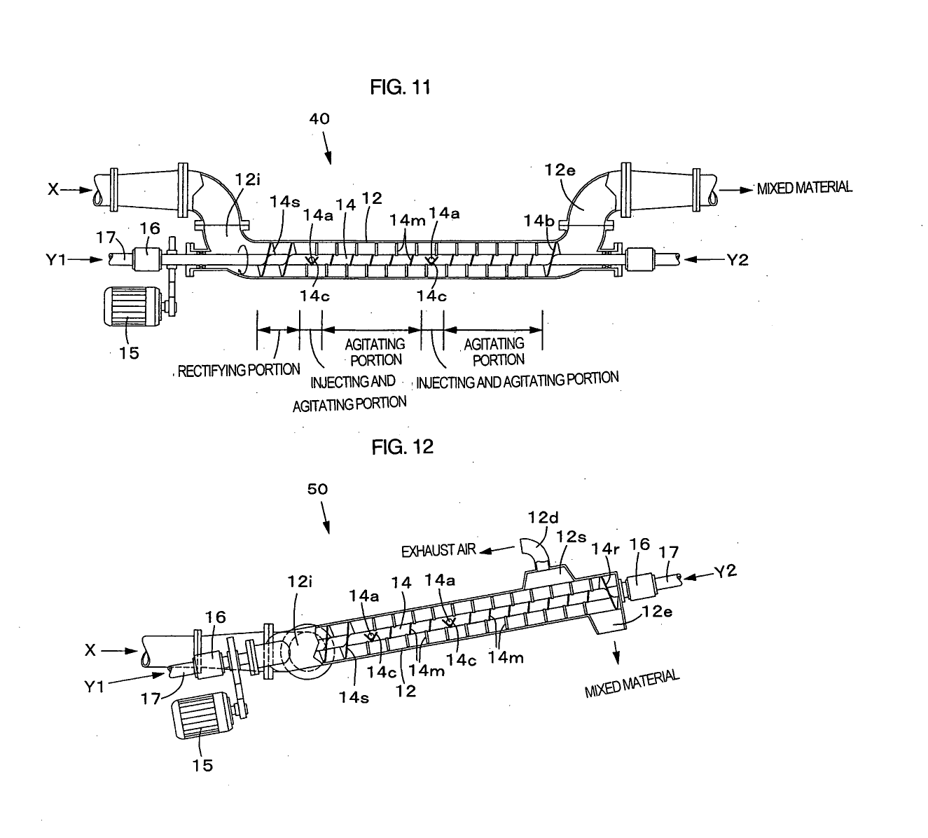

Specifically, as shown in FIGS. 11 and 12, the structure can be made such that the corresponding portion to the agitating blade 14m is made larger, and a plurality of supply ports are provided in the corresponding portion to the agitating blade 14m in the shaft member 14 at a predetermined interval. An example shown in FIG. 11 and an example shown in FIG. 12 are respectively obtained by modifying the second example mentioned above and the third example mentioned above, and adding one supply port 14a of the shaft member, and basic structures thereof are made as mentioned above. In this case, in these examples 40 and 50, the downstream side end portion of the shaft member 14 is introduced out of the mixing pipe passage 12 in a penetrating manner, and a portion between the upstream side supply port 14a and the downstream side supply port 14a within the shaft member 14 is shut off by an occlusion member (not shown). Accordingly, if the first added and mixed material Y1 is supplied from the upstream side end portion of the shaft member 14, the material Y1 is supplied from the upstream side supply port 14a into the mixing pipe passage 12, and is mixed with the first fluid material X by the agitating blade 14m positioned between the upstream side and downstream side supply ports 14a and 14a. Further, if the later added and mixed material Y2 is supplied from the downstream side end portion of the shaft member 14, the material Y2 is supplied from the downstream side supply port 14a into the mixing pipe passage 12, and is mixed with the first fluid material X mixed with the material Y1 by the agitating blade 14m positioned in the downstream side of the downstream side supply port 14a.

In this case, the material Y1 supplied from the upstream side supply port 14a and the material Y2 supplied from the downstream side supply port may be made the same or may be different. Further, it is possible to increase the number of the supply port of the shaft member 14, and in this case, the shaft member 14 may be formed as a multi-pipe structure and the supply passage of the fluid material may be formed via the gap within the pipe passage and between the pipe passages (not shown).

### EXAMPLE THAT A PLURALITY OF PIPE-TYPE MIXERS ARE CONNECTED IN SERIES

The pipe-type mixer in accordance with the present invention can mix with the other additive material (the second fluid material) in the material carrying process by being interposed as a part of the material carrier pipe passage. In the case that the additive material is constituted by one kind or the case that plural kinds of additive materials can be supplied via a common pipe passage, it is sufficient that only one pipe-type mixer is placed in one carrier line. However, in the case that plural kinds or the same kind of additive materials are added and mixed step by step, it is possible to connect a plurality of pipe-type mixer apparatuses directly or indirectly via the other apparatus and pipe passage, and it is possible to add and mix the additive material in sequence in each of the pipe-type mixer apparatuses.

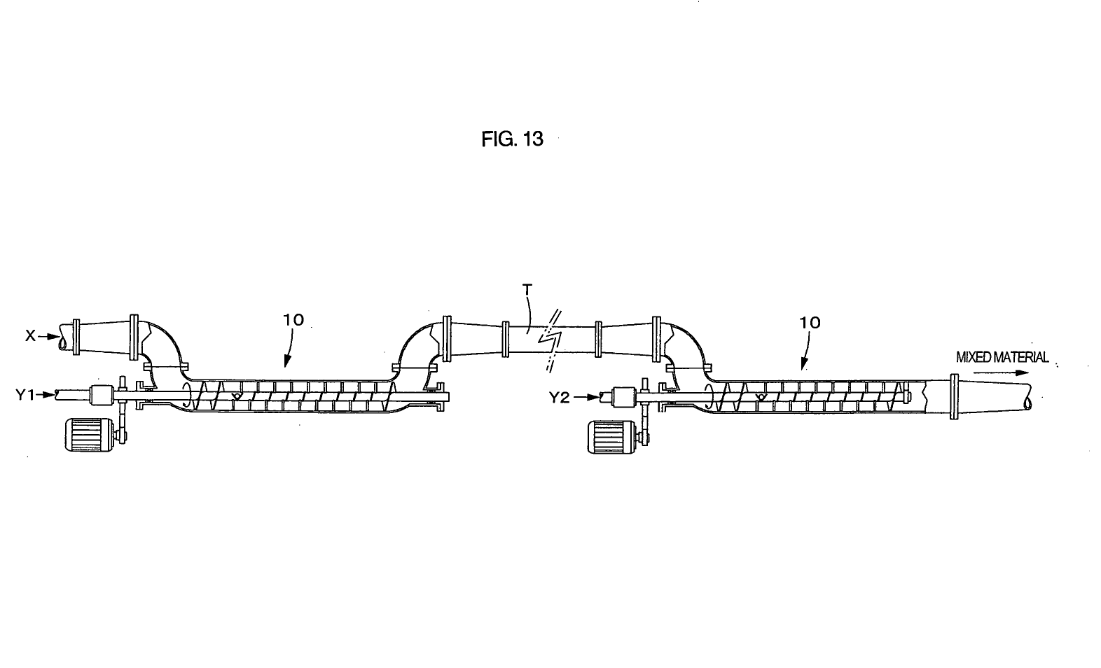

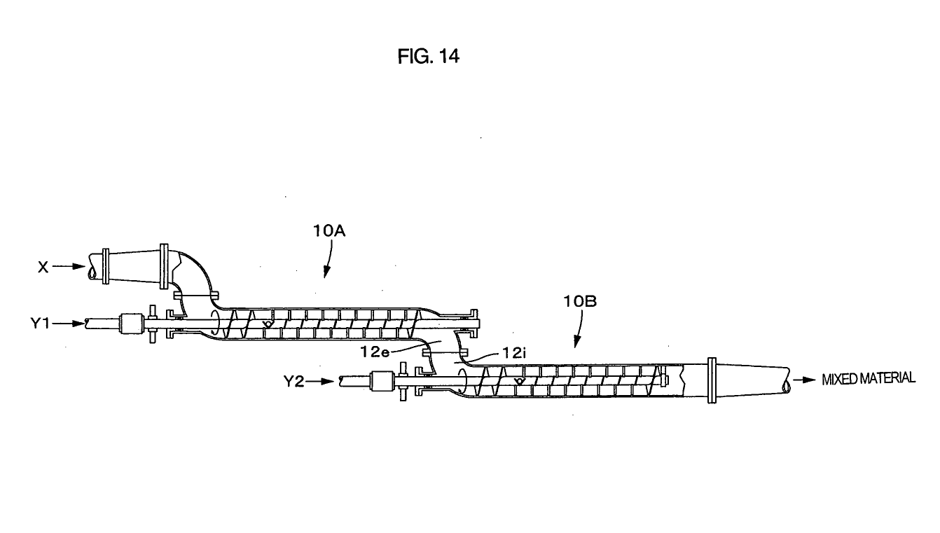

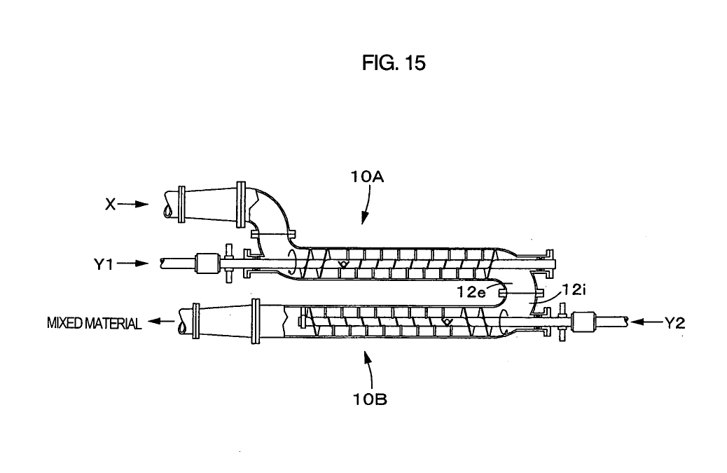

Concrete examples of this structure are shown in FIGS. 13 to 15. The example shown in FIG. 13 is structured such that the mixers 10 and 10 in accordance with the first example mentioned above are connected in series via a carrier pipe T, and the second and third fluid materials Y1 and Y2 are mixed with the first fluid material X in sequence. Further, the example shown in FIG. 14 is structured such as to arrange a pipe-type mixer 10A having a discharge port 12e open to a lower side in an upstream side, arrange a pipe-type mixer 10B having a supply port 12i open to an upper side in a downstream side, directly connect the downward discharge port 12e of the upstream side mixer 10A to the upward supply port 12i of the downstream side mixer 10B, and integrally form both the mixers 10A and 10B. The structure having a plurality of mixing portions is included in the pipe-type mixer in accordance with the present invention. In the example shown in FIG. 14, any one mixer 10A can be arranged in a position which is rotated at an optional angle around the connection portion with respect to another mixer 10B, in correspondence to the positional relation between a start of transfer and a transfer target. For example, as shown in FIG. 15, it is possible to employ a U-shaped arrangement in which the material is transferred so as to be returned.

In this case, in the concrete embodiments, of course, it is possible to use the other pipe-type mixers mentioned above (not shown).

In this case, the method of producing the lightweight solidifying material mentioned above is obtained by applying the series aspect, however, the series connecting aspect of the pipe-type mixer in accordance with the present invention is not limited to the method of producing the lightweight solidifying material mentioned above. For example, contrary to the method of manufacturing the lightweight solidifying material mentioned above, it is possible to use in an aspect of supplying the lightening material in the first pipe-type mixer 4 and mixing the solidifying material in the second pipe-type mixer 5.

### <Embodiment of Solidifying Material Supply Apparatus>

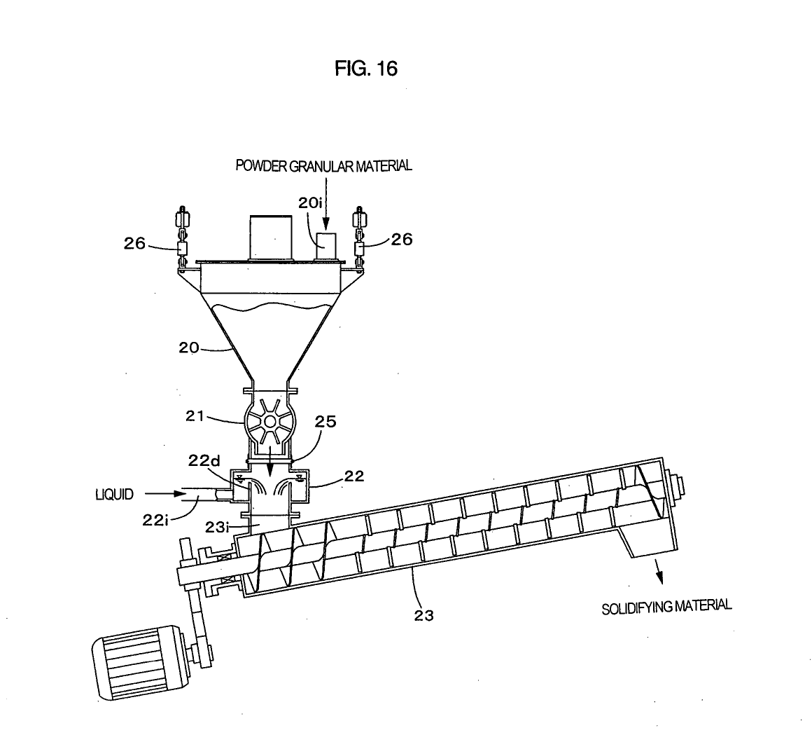

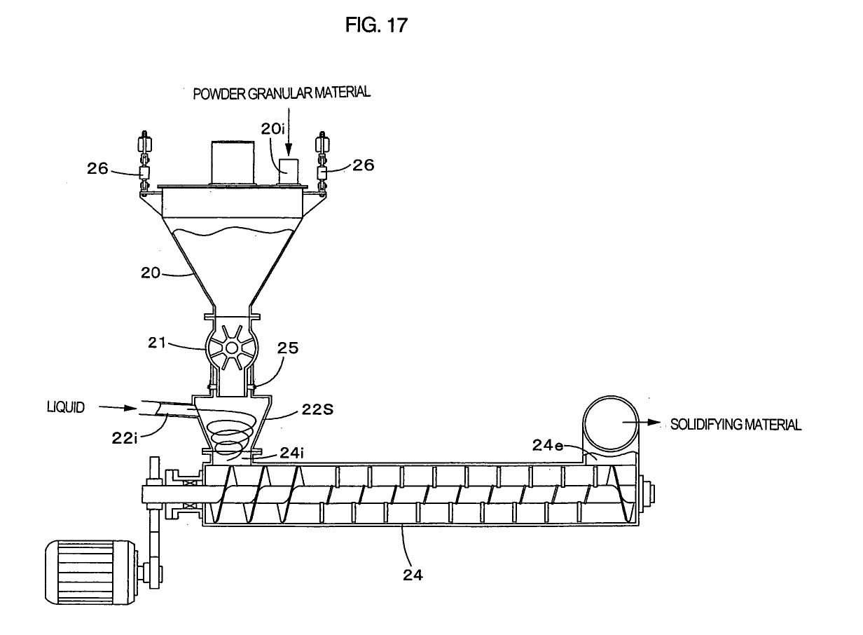

FIG. 16 shows an example of a solidifying material supplying apparatus in accordance with the present invention. Reference numeral 20 denotes a powder granular material reserving hopper for temporarily reserving the powder granular material such as the cement or the like. For example, the powder granular material reserved in the silo or the like is supplied within the hopper 20 from the supply port 20i in an upper portion as occasion demands.

The powder granular material solidifying material supplied to the hopper 20 is taken out by a quantitative taking out apparatus (a rotary feeder in the illustrated example) 21, is dropped and discharged from the discharge port, and is input to a supply portion 23i of an agitating and mixing apparatus 23 through a center portion in a diametrical direction of a linear combining pipe passage 22 along a perpendicular direction. An annular liquid reserving dam 22d is provided in a periphery of the center portion to which the powder granular material is dropped and circulated, within the combining pipe passage 22, and a liquid supply pipe 22i penetrating the pipe wall is communicated with an inner side of the dam 22d (an outer side with respect to the center portion). Accordingly, when supplying the liquid (the water, the additive material or the like) from the liquid supply pipe 22, the liquid is temporarily reserved within the dam 22d, and thereafter flows over the dam 22d so as to be supplied to the center portion in a cascade shape. On the other hand, since the agitating and mixing apparatus 23 is basically the same as the structure obtained by omitting the hopper, the rotary feeder and the exhausting means from the pipe-type mixer shown in FIG. 7 mentioned above, a description thereof will be omitted.

In the solidifying material supply apparatus structured in the manner mentioned above, the powder granular material dropped and supplied into the combining pipe passage 22 is nipped or narrowed down by the liquid which flows over the peripheral dam 22d so as to be supplied in the cascade shape, in the process of passing through the center portion within the combining pipe passage 22, and is combined with the liquid so as to be wrapped by the liquid. The combined powder granular material and liquid are agitated and mixed by the agitating and mixing apparatus 23 and are thereafter delivered to the external portion.

FIG. 17 shows another example of the solidifying material supply apparatus in accordance with the present invention. In this aspect, the combining pipe passage is constituted by a cyclone chute 22S formed in an inverted circular truncated cone shape, and is mainly different from the aspect shown in FIG. 16 in a point that the liquid supply pipe 22i is communicated with an inner wall of the upper portion thereof so as to face in an inner peripheral direction. In this case, the liquid supplied from the liquid supply pipe into the cyclone chute is swirled and dropped along the inner peripheral surface. Accordingly, the powder granular material dropped and supplied into the cyclone chute 22S is dropped within a swirling dropping portion of the liquid, and is combined so as to be wrapped by the liquid. The agitating and mixing apparatus 23 is constituted by a pipe-type mixer, has a horizontal straight-pipe type mixing pipe passage in which a supply port 24i communicated with a lower portion of the cyclone chute 22S is formed in an upstream side upper portion, and a discharge port 24e is formed in an upper portion of a downstream side end portion, and is of a type that the mixed material is discharged from the discharge port 24e in accordance with an overflow.

In these examples, since the powder granular material is combined so as to be wrapped by the liquid, both the elements can be securely and continuously combined without attachment of the powder granular material to the periphery such as the inner surface of the combining pipe passage, the inner surface of the agitating and mixing apparatus, and the like. As a result, there can be obtained an advantage that it is impossible to obtain the solidifying material at a more accurate blending ratio.

Further, in these examples, the structure is made such that the hopper 20 and the quantitative taking out apparatus 21 are connected to the combining pipe passage 22 or the like via a flexible joint 25 as illustrated, and are suspended via load cells 26 and 26, and it is possible to measure an amount of the reserved powder granular material within the hopper 20 and the quantitative taking out apparatus 21 on the basis of the measurement value of the load cell 26. Further, it is possible to employ a method of controlling an amount by supplying the liquid from the quantitative pump via the flow meter, and a method of supplying the liquid from a water tank or a water hopper via a rotary feeder (not shown). Further, in the embodiment mentioned above, the pipe-type mixer is used as the agitating and mixing apparatuses 23 and 24, however, it is possible to employ a batch type or a continuous type agitator.

### <Embodiment of Gravity Adjusting Apparatus>

For example, as mentioned above, in the case of utilizing the material having the unstable quality such as the dredge mud, it is important to control the quality thereof. One of main parameters is a gravity control. The gravity control of the fluid material containing the water content and the solid content is to adjust the moisture content. In this case, there is proposed a gravity adjusting apparatus which can correspond to the moisture material having the wide moisture ratio and the case that the fluctuation width of the moisture ratio is large.

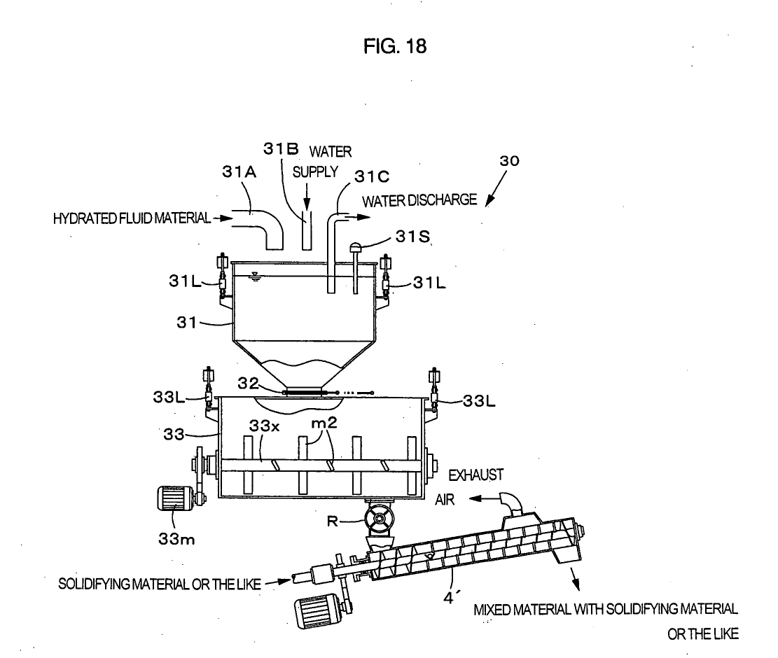

FIG. 18 shows an example of a gravity adjusting apparatus 30 in accordance with the present invention. The gravity adjusting apparatus 30 is provided with a gravity adjusting tank 31 as a main structure. The gravity adjusting tank 31 is provided with a water level sensor 31S as a volume measuring means for measuring a volume of the fluid material within the tank. In other words, since the gravity adjusting tank has a fixed volumetric capacity, the volume of the fluid material within the tank can be measured only by measuring the water level by the water level sensor 31S.

Further, in the illustrated aspect, the gravity adjusting tank 31 is suspended by load cells 31L and 31L, and is structured such that a weight of the fluid material within the tank can be measured by the load cells 31L. Further, it is possible to determine the gravity of the fluid material within the tank 31 on the basis of the measurement results. The gravity is measured, for example, by a control apparatus (not shown).

Further, a fluid material supply pipe 31A and a water supply pipe 31B into the tank 31 are open to the upper side, and a suction pipe 31C for sucking a clear supernatant liquid is inserted to an upper portion within the tank 31.

In the gravity adjusting tank 31 structured in the manner mentioned above, the gravity of the fluid material is measured by weighing the volumetric capacity and the mass of the fluid material input within the tank 31 by means of the water level sensor 31S and the load cells 31L, and the gravity can be adjusted by sucking and discharging a desired amount of water via the suction pipe 31C in the case that the gravity is less than a desired gravity, and by adding a desired amount of water via the water supply pipe 31B in the case that the gravity is larger than the desired gravity. In other words, the gravity adjusting tank 31 is structured as a system of waiting sedimentation and precipitation of the soil particles so as to discharge the clear supernatant liquid in the case the water discharge is required, mainly on the basis of the water addition. In this case, this motion can be carried out by a control apparatus (not shown).

On the other hand, in the present embodiment, a discharge port is provided in a bottom portion of the gravity adjusting tank 31, and the discharge port is communicated with an agitator tank 33 (an agitating and mixing means) via a valve such as a gate valve 32 or the like. Accordingly, the gravity adjusted fluid material is supplied to the agitator tank 33 by opening the gate valve 32, and is agitated and mixed. Since the separation of the water content from the solid content is promoted by temporarily reserving the fluid material within the gravity adjusting tank 31, it is desirable that the gravity adjusted fluid material is supplied to the outer portion via the agitating and mixing process.

The agitator tank 33 in accordance with the illustrated example is structured such that an agitating shaft 33x extending along a horizontal direction is pivoted to a lower portion, a lot of agitating blades m2 having a carrying function and an agitating function are provided in an outer periphery of the agitating shaft 33x, the agitating shaft 33x is connected to a rotation driving source 33m in an outer side of the tank 33 so as to be rotated, and a discharge port is formed in an agitator tank bottom portion at a downstream side position in a material carrying direction by the agitating blade m2.

Further, the illustrated gravity adjusting apparatus is based on the producing method shown in FIG. 2 mentioned above, and is structured such that a pipe-type mixer 4′ is connected to the discharge port of the agitator tank 33 via a quantitative taking out apparatus R (a rotary feeder in the illustrated embodiment), and the fluid material agitated within the agitator tank 33 is taken out by the taking out apparatus R, and is quantitatively supplied to the pipe-type mixer 4′. Further, in this case, in order to improve a supply accuracy to the pipe-type mixer 4′, in the illustrated aspect, it is desirable to structure such as that the agitator tank 33 is suspended by load cells 33R and 33R, and the rotation of the quantitative taking out apparatus R is controlled in correspondence to a fluid material quantity possessed within the agitator tank 33 measured by the load cells 33R.

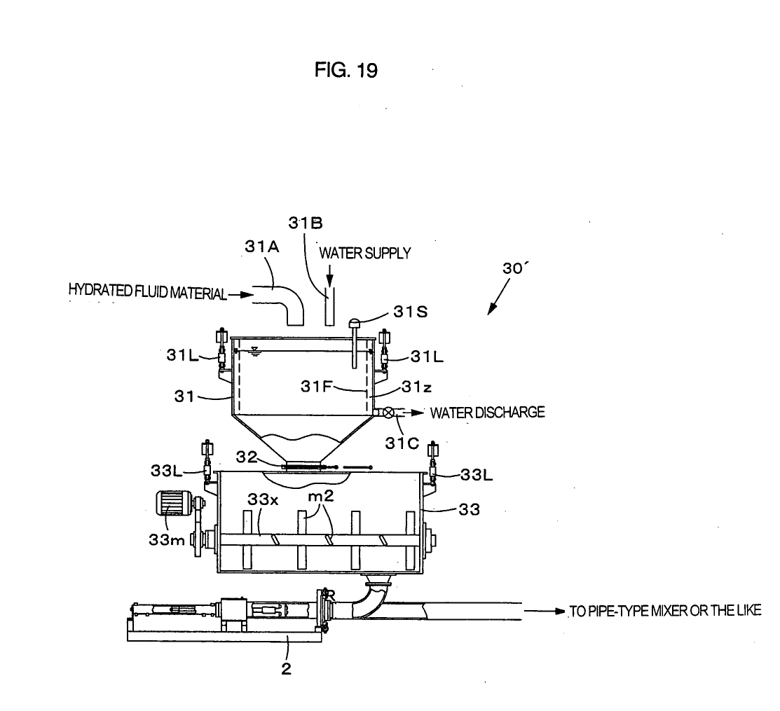

On the contrary, FIG. 19 shows an example that the water content of the fluid material reserved within the gravity adjusting tank 31 is positively sucked and discharged via a filter medium 31F (even in the case of discharging the clear supernatant liquid as mentioned above, it is possible to suck via the filter medium).

In more detail, the filter medium 31F such as a filter fabric or the like is built within the gravity adjusting tank 31 so as to surround a center portion, the filter medium 31F shuts off a portion within the surrounded portion and a water discharge space 31z between an outer surface of the filter medium 31F and an inner surface of the tank 31, and the suction pipe 31C is penetrated the tank wall so as to face to an inner side of the drain space 31z. Further, the fluid material supply pipe 31A and the water supply pipe 31B into the tank 31 are open to an upper side within the surrounded portion by the filter medium 32F.

In this case, when the fluid material is supplied into the filter medium 31F surrounded portion within the adjusting tank 31 at a time of discharging water, only water exudes to the water discharge space 31z through the filter medium 31F on the basis of its own weight pressure, so that the exuding water is sucked and discharged at a desired amount via the suction pipe 31C.

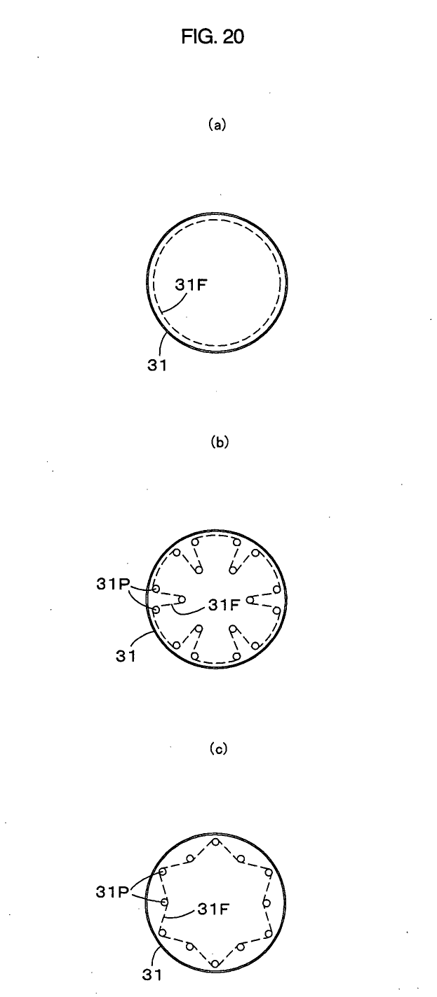

In the present embodiment, as far as the function mentioned above can be achieved, the arrangement of the filter medium 31F is optional. In the case that the filter fabric is used as the filter medium, it is possible to arrange a cylindrical filter fabric along an inner peripheral wall of the adjusting tank 31 as shown in FIG. 20(a), it is possible to provide with a necessary number of filter fabric supporting members 31P and 31P in a standing manner so as to locally protrude to a center side at a predetermined interval in a peripheral direction as shown in FIG. 20(b), and it is possible to arrange the filter fabric supporting members 31P in a six-apex star shape as shown in FIG. 20(c).

Further, the gravity adjusting apparatus 30′ shown in FIG. 19 is based on the manufacturing method shown in FIG. 1 mentioned above, and is structured such that the piston pump 2 is connected to the discharge port of the agitator tank 33, and it is possible to suck and take out the fluid material from the agitator tank 33 and to deliver the fluid material to the external portion (the first pipe-type mixer 4 in the aspect shown in FIG. 1), by means of the piston pump 2.

As mentioned above, in accordance with the present invention, it is possible to mix at a stable rate. Further, it is possible to produce the even lightweight solidifying material from the mud and the muddy water.

1. A method of manufacturing a lightweight solidifying material or changing a fluid raw material containing a water content and a solid content to a lightweight solidifying material while carrying the fluid raw material to a destination place, by using a pipe-type mixer which is provided with a mixing pipe passage, a shaft member coaxially pivoted within the mixing pipe passage, a screw vane and an agitating blade arranged in parallel in the order from an upstream side on the outer surface of the shaft member, a rotation driving means of the shaft member, and at least one additive material supplying port arranged in a corresponding position to the agitating blade in the shaft member, and which is structured such as to carry the fluid material supplied into the mixing pipe passage to the additive material supplying port via the rotated screw vane, thereafter supply an additive material to the fluid material from the additive material supplying port, and agitate and mix the fluid material and the additive material by the rotated agitating blade, comprising:
(A) a step of adjusting a gravity of the fluid raw material by adding or removing a water content;
(B) a step of continuously carrying the gravity adjusted fluid raw material via a carrier passage constituted by a pipe passage in which at least one pipe-type mixer is interposed;
(B1) a solidifying material adding step of adding and mixing a solidifying material as an additive material to the fluid raw material under the carrying step by the pipe-type mixer interposed in the middle of the carrier passage; and
(B2) a lightweight material adding step of adding and mixing a lightening material as an additive material to the fluid raw material obtained by adding the solidifying material by another pipe-type mixer interposed in a downstream side of the pipe-type mixer in the solidifying material adding step; or supplying the lightening material from another additive material supply port of the pipe-type mixer in the solidifying material adding step and adding and mixing the lightening material to the fluid raw material obtained by adding the solidifying material.

2. A method of manufacturing a lightweight solidifying material as claimed in claim 1, wherein a pressure pump is interposed in an upstream side of the pipe-type mixer adding the solidifying material in the carriage passage, and each of the additive materials is added and mixed while passing the gravity adjusted fluid raw material through the pipe-type mixer by utilizing a pressure of the pressure pump.

3. An apparatus for manufacturing a lightweight solidifying material or for changing a fluid raw material containing a water content and a solid content to a lightweight solidifying material while carrying the fluid raw material to a destination place, by using a pipe-type mixer which is provided with a mixing pipe passage, a shaft member coaxially pivoted within the mixing pipe passage, a screw vane and an agitating blade arranged in parallel in the order from an upstream side on the outer surface of the shaft member, a rotation driving means of the shaft member, and at least one additive material supplying port arranged in a corresponding position to the agitating blade in the shaft member, and which is structured such as to carry the fluid material supplied into the mixing pipe passage to the additive material supplying port via the rotated screw vane, thereafter supply an additive material to the fluid material from the additive material supplying port, and agitate and mix the fluid material and the additive material by the rotated agitating blade, comprising:
(a) a means for adjusting a gravity of the fluid raw material by adding or removing a water content;
(b) a structure for continuously carrying the gravity adjusted fluid raw material via a carrier passage constituted by a pipe passage in which at least one the pipe-type mixer is interposed;
(b1) a structure for adding and mixing a solidifying material as an additive material to the fluid raw material under the carrying step by the pipe-type mixer interposed in the middle of the carrier passage; and
(b2) a structure for adding and mixing a lightening material as an additive material to the fluid raw material obtained by adding the solidifying material by another pipe-type mixer interposed in a downstream side of the pipe-type mixer in the solidifying material adding step; or supplying the lightening material from another additive material supply port of the pipe-type mixer in the solidifying material adding step and adding and mixing the lightening material to the fluid raw material obtained by adding the solidifying material.

4. A pipe-type mixer apparatus comprising:
a mixing pipe passage having an upstream side supply portion to which a first fluid material is pressure supplied and a downstream side discharge portion from which a mixed material is discharged;
a shaft member coaxially pivoted within the mixing pipe passage;
a screw vane and an agitating blade arranged in parallel in the order from an upstream side on the outer surface of the shaft member;
a rotation driving means of the shaft member; and
a second fluid material supplying port arranged in a corresponding position to the agitating blade in the shaft member,
wherein the pipe-type mixer is structured such as to rectify the first fluid material supplied into the mixing pipe passage by the rotated screw vane, thereafter supply the second fluid material to the first fluid material from the supplying port in the shaft member, agitate and mix the first fluid material and the second fluid material by the rotated agitating blade, and discharge the agitated and mixed material via the discharge portion.

5. A pipe-type mixer apparatus as claimed in claim 4, wherein a rectifying capacity per unit time achieved by the screw vane is equal to or more than a supply amount of the first fluid material per unit time.

6. A pipe-type mixer apparatus as claimed in claim 4, further comprising:
a mixing pipe passage having an upstream side supply portion to which a first fluid material is supplied in a non-pressurized state and a downstream side discharge portion from which a mixed material is discharged;
a shaft member coaxially pivoted within the mixing pipe passage;
a screw vane and an agitating blade arranged in parallel in the order from an upstream side on the outer surface of the shaft member;
a rotation driving means of the shaft member; and
a second fluid material supplying port arranged in a corresponding position to the agitating blade in the shaft member,
wherein the screw vane carries and discharges the first fluid material supplied within the mixing pipe passage on the basis of an extruding effect, and
wherein an extrusion amount per unit time achieved by the screw vane is equal to or more than a supply amount of the first fluid material per unit time.

7. A pipe-type mixer apparatus as claimed in claim 4, wherein a supply port of the first fluid material is provided in a corresponding position to the upstream side supply portion in the shaft member.

8. A pipe-type mixer apparatus as claimed in claim 6, wherein a hopper is connected to the upstream side supply portion of the mixing pipe passage, and the first fluid material reserved within the hopper is taken out by a quantitative feeder so as to be supplied to the upstream side supply portion.

9. A pipe-type mixer apparatus as claimed in claim 4, wherein the mixing pipe passage is structured such that a part or all of the downstream side of the agitating blade is positioned in an upper side of the corresponding portion to the screw vane and the agitating blade, whereby the first fluid material, the second fluid material and the mixed material are always filled at least in the downstream side portion of the screw vane.

10. A pipe-type mixer apparatus as claimed in claim 4, wherein a boost screw vane promoting the delivery of the mixed material to the downstream side discharge portion is provided in a downstream side of the agitating blade in the shaft member.

11. A pipe-type mixer apparatus as claimed in claim 4, wherein a cover member is provided in a front side of the second fluid material supplying port in the shaft member in a rotating direction of the shaft member, the cover member rotates together with the shaft member and the agitated material is pushed away, whereby a supply space for the second fluid material is formed in a second fluid material supply port position.

12. A pipe-type mixer apparatus as claimed in claim 4, wherein the agitating blade includes a double function blade having an agitating operation and a mixed subject carrying operation, and a single function blade having only the agitating operation, and the double function blade and the single function blade are arranged along a spiral direction around the shaft member in accordance with an alternate arrangement such that one single function blade is interposed every one or two double function blade.

13. A pipe-type mixer apparatus as claimed in claim 4, wherein the agitating blade is formed in an elongated flat shape, and a plurality of the agitating blades are arranged along a spiral direction around the shaft member at a phase interval of 90 degree or 60 degree.

14. A pipe-type mixer apparatus as claimed in claim 4, wherein the screw vane is formed such that a winding number is between 1 and 3, and a pitch is 0.4 to 0.8 times of a diameter of the mixing pipe,
wherein the agitating blade is arranged in 5 to 15 pitches at an interval between 4 and 6 sheets per 1 pitch, along a spiral direction around the shaft member,
wherein a rotational speed of the shaft member is between 150 and 200/πd (rpm) at a time of driving the apparatus, in which a diameter of the screw vane and the agitating blade is set to d, and
wherein a material flow speed v within the mixing pipe passage at a time of driving the apparatus is between 10 and 50 m/min.

15. A solidifying material supplying apparatus for mixing a powder granular material and a liquid so as to produce a solidifying material, and supplying the solidifying material to an external portion, comprising:
a means for dropping and supplying the powder granular material;
a means for supplying the liquid in a cascade to the dropping powder granular material in such a manner as to pinch or narrow down the powder granular material from the periphery of the powder granular material, and combining the powder granular material with the liquid; and
an agitating and mixing means for agitating and mixing the combined powder granular material and the liquid.

16. A solidifying material supplying apparatus for mixing a powder granular material and a liquid so as to produce a solidifying material, and supplying the solidifying material to an external portion, comprising:
a means for dropping and supplying the powder granular material;
a means for swirling and dropping the liquid and dropping the powder granular material to the swirling portion, and combining the powder granular material with the liquid; and
an agitating and mixing means for agitating and mixing the combined powder granular material and the liquid.

17. A gravity adjusting apparatus comprising:
a gravity adjusting tank to which a fluid material including a moisture content and a solid content is input;
a volume measuring means for measuring a volume of the fluid material within the gravity adjusting tank;
a weight measuring means for measuring a weight of the fluid material within the gravity adjusting tank;
a gravity measuring means for determining a gravity on the basis of results of the volume measuring means and the weight measuring means;
a water adding means for adding water into the gravity adjusting tank in correspondence to the measurement results of the gravity measuring means, in such a manner that the fluid material within the gravity adjusting tank has a predetermined gravity; and
a water discharging means for discharging water from the gravity adjusting tank in correspondence to the measurement results of the gravity measuring means, in such a manner that the fluid material within the gravity adjusting tank has a predetermined gravity.

18. A gravity adjusting apparatus as claimed in claim 17, wherein the water discharging means is structured such as to suck and discharge a clear supernatant water of the fluid material reserved within the gravity adjusting tank.

19. A gravity adjusting apparatus as claimed in claim 17, wherein the water discharging means is structured such as to suck and discharge the water content of the fluid material reserved within the gravity adjusting tank via a filter medium.

20. A gravity adjusting apparatus as claimed in claim 17, wherein the gravity adjusting apparatus is provided with an agitating and mixing means for agitating and mixing the gravity adjusted fluid material, and a delivering means for delivering the agitated and mixed fluid material to an external portion.
